(19) United States
(12) Patent Application Publication
(10) Pub. No.: US 2010/0221063 A1
(43) Pub. Date: Sep. 2, 2010

(54) WELD MEDIUM FOR DISSIMILAR MATERIALS

(76) Inventors: Carl David Hardison, III, Preston, IA (US); Peter S. Schulte, East Dubuque, IL (US); Thomas Jansen, Dubuque, IA (US)

Correspondence Address: HANLEY, FLIGHT & ZIMMERMAN, LLC, 150 S. WACKER DRIVE, SUITE 2100, CHICAGO, IL, 60606, US

(21) Appl. No.: 12/396,094

(22) Filed: Mar. 2, 2009

(51) Int. Cl. F16B 5/08; B31B 1/60; B29C 65/06

(52) U.S. Cl. 403/270; 156/60; 156/73.5

(57) ABSTRACT

An example of a door curtain having pieces comprised of different thermoplastic materials includes a weld medium that facilitates the welding of two thermoplastics that are otherwise not readily welded together. In some examples, the weld medium comprises two outer layers that are joined to each other, wherein one layer is of the same polymer as one of the curtain pieces, and the other opposite layer is made of the same polymeric material as that of the other curtain piece. The weld medium is sandwiched between the two curtain pieces such that matching materials of the curtain and weld medium face each other. The two curtain pieces, with the weld medium between the two, are then thermally or ultrasonically welded together. The weld medium can be made by coating a fabric sheet with the two different plastic layers bonded to opposite sides of the fabric sheet.

### FIELD OF THE DISCLOSURE

This patent generally pertains to welding of plastic sheets and, more specifically, to a weld medium for such a process.

### BACKGROUND

Vertical operating doors often include a roll-up curtain for opening and closing the door. Other types of doors have curtains that operate in a translating and/or folding manner. In any case, door curtains can be made of various materials such as vinyl, polyurethane or polypropylene. Each material has its advantages and disadvantages.

Polyurethane, for example, has very good wear properties but is expensive and subject to UV deterioration. Vinyls have good UV properties but tend to get stiff and brittle at low temperatures. Polypropylene has good weather resistance and is relatively inexpensive, but it has relatively poor wear resistance.

### BRIEF DESCRIPTION OF THE DRAWINGS

FIG. 1 is a front view of an example closed door that includes an example weld medium.

FIG. 2 is a front view of the door of FIG. 1 but showing the door partially open.

FIG. 3 is a front view of the door of FIG. 1 but showing the door fully open.

FIG. 4 is a cross-sectional view taken along line 4-4 of FIG. 1.

FIG. 5 is a perspective view showing the assembly of an example weld medium.

FIG. 6 is a perspective view showing the weld medium of FIG. 5 being inserted between two different plastic sheets.

FIG. 7 is a perspective view showing the illustrated pieces of FIG. 6 being welded together.

FIG. 8 is a front view of another example weld medium.

FIGS. 9A-F are schematic views illustrating an example process of producing an example weld medium.

FIG. 10 is a perspective view similar to FIG. 6 but showing an alternate example weld medium.

FIG. 11 is a perspective view similar to FIG. 7 but showing the weld medium of FIG. 10.

FIG. 12 depicts example sheets and an example weld medium.

FIG. 13 depicts the weld medium of FIG. 12 welding the example sheets of FIG. 12 together.

### DETAILED DESCRIPTION

Certain examples are shown in the above-identified figures and described in detail below. In describing these examples, like or identical reference numbers are used to identify the same or similar elements. The figures are not necessarily to scale and certain features and certain views of the figures may be shown exaggerated in scale or in schematic for clarity and/or conciseness. Additionally, several examples have been described throughout this specification. Any features from any examples may be included with, a replacement for, or otherwise combined with other features from other examples.

While different materials are available that have advantages and disadvantages, it is difficult to create a single door curtain with a broad range of ideal qualities.

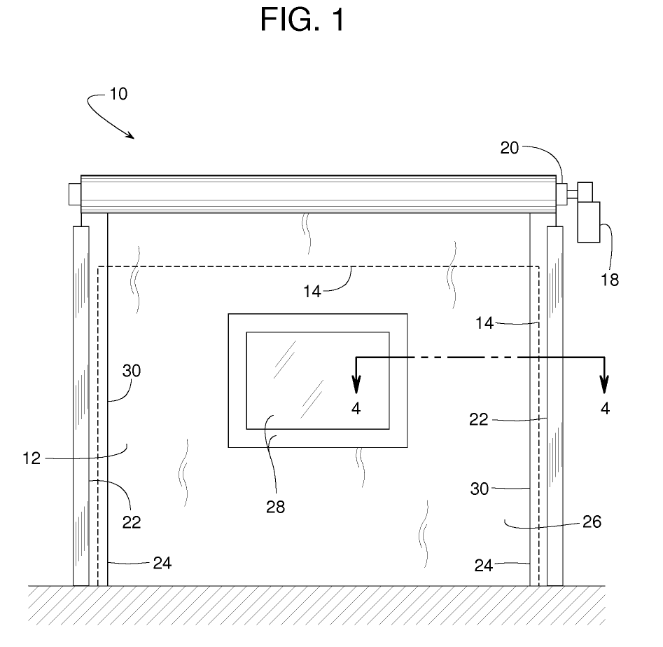

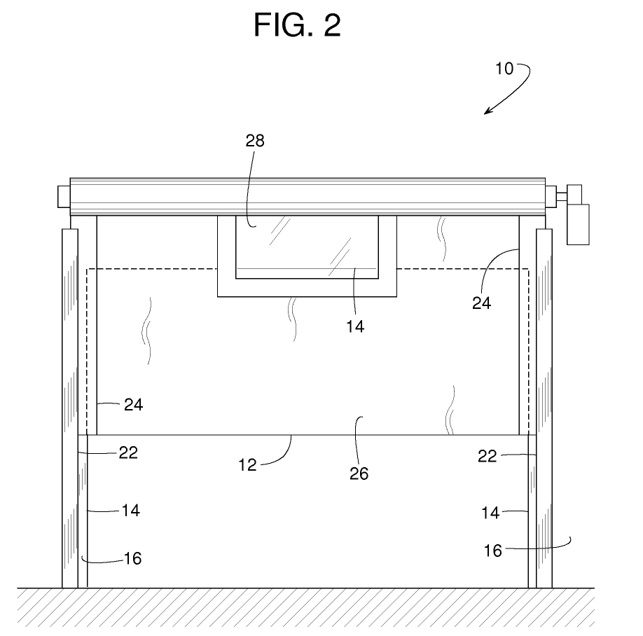

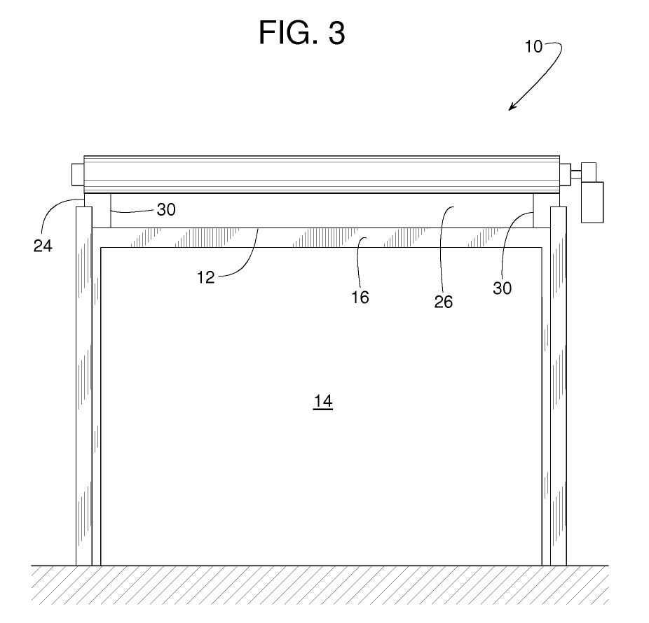

FIGS. 1-3 show an example door 10 with a roll-up curtain 12. Curtain 12 is comprised of multiple sheets of different materials that are joined by an example weld medium. FIG. 1 shows door 10 closed in front of a doorway 14 in a wall 16, FIG. 2 shows door 10 partially open, and FIG. 3 shows door 10 fully open. For sake of example, door 10 is operated by a drive unit 18 that rotates a drum 20 in a selective direction to take up or pay out curtain 12. As door 10 opens or closes, guide tracks 22 help guide the vertical movement of the curtain's lateral edges 24. Others means for moving curtain 12 across doorway 14 are certainly well within the scope of this disclosure.

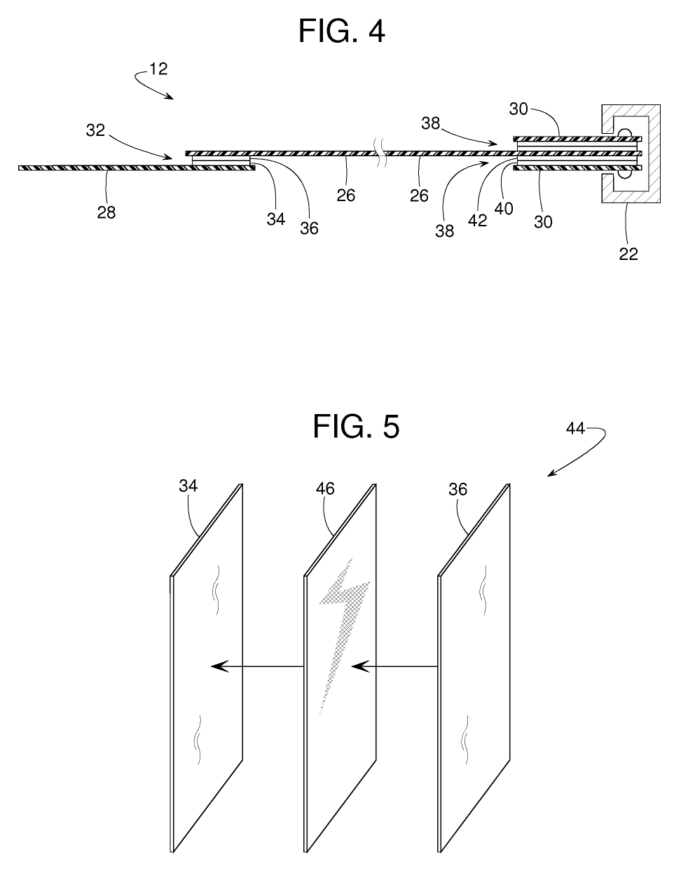

To meet various design needs, the illustrated examples of curtain 12 is comprised of three different sheets of material, as shown in FIG. 4. A first main sheet 26 is made of a first polymer such as polypropylene for its favorable weather resistance properties and reasonable cost. A second sheet 28, for a window, is made of a second polymer such as vinyl, which is transparent and has good UV resistance. To protect the curtain's lateral edges 24 as they slide along guide tracks 22, a third sheet 30 is made of a third polymer such as polyurethane for its favorable wear resistance properties.

Although the various sheets of curtain 12 could be sewn together, it can be awkward sewing large, cumbersome sheets of material. Moreover, the resulting seams can be vulnerable to wear, and the seams may create crevices that tend to harbor mold and bacteria. Thus, the sheets 26, 28 and 30 of curtain 12 preferably are welded to each other by way of ultrasonic vibration or heat. Sheets of certain dissimilar materials, however, are not always readily weldable to each other because of their different material properties. Sheets of dissimilar materials are referred to herein by the term “distinguishable materials.” The term, “weld” means melting at least the surface of two proximal pieces so that the two pieces become joined (i.e., connected or coupled to each other) and/or molecularly bonded.

Referring to FIG. 4, in order to weld vinyl sheet 28 to main polypropylene sheet 26, a weld medium 32 first is inserted between sheets 26 and 28. Weld medium 32 has a first layer 34 comprising a vinyl polymer and an opposite-side second layer 36 comprising a polypropylene polymer. First layer 34 (e.g., vinyl layer) is weldable to second sheet 28 (e.g., vinyl sheet), and second layer 36 (e.g., polypropylene layer) is weldable to the first sheet 26 (e.g., main polypropylene sheet).

A second weld medium 38 is used for joining the first sheet 26 (e.g., main polypropylene sheet) to a third sheet 30 (e.g., a polyurethane sheet). The second weld medium 38, however, has a first layer 40 comprising polyurethane for welding to the polyurethane sheet 30 and an opposite-side layer 42 comprising polypropylene for welding to the main polypropylene sheet 26. To join other combinations of sheet materials, different weld media can have different types of layers, such as polyurethane and vinyl, or just about any other imaginable combination of two thermoplastic materials.

For the examples illustrated in FIGS. 5-7, a weld medium 44 (similar to weld medium 32) can be made by bonding external layers 34 and 36 to opposite sides of an intermediate layer 46. Intermediate layer 46 can be a fabric material (e.g., a woven material), or intermediate layer 46 can be any other material that can be coated with the desired polymers. Intermediate layer 46 (e.g., fabric layer) can be coated with layers 34 and 36 in any suitable manner well known to those of ordinary skill in the art of plastic coating fabrics. When coating intermediate layer 46, the vinyl, polypropylene, polyurethane or other chosen polymer tends to cling to the porosity and/or strands and fibers of intermediate layer 46. Moreover, other processes besides coating for applying layers 34 and 36 to the intermediate layer 46 could be used.

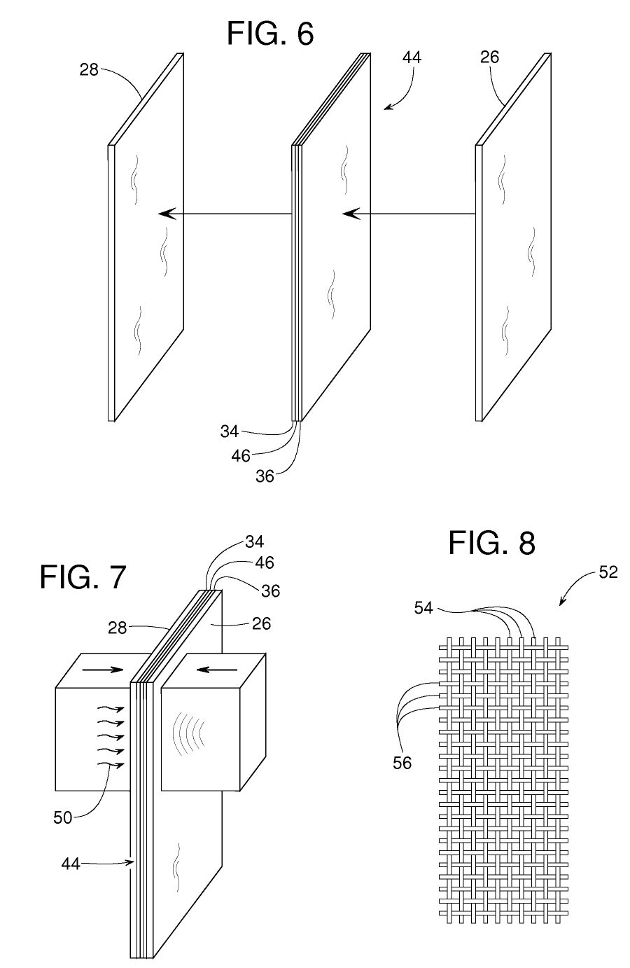

FIG. 5 shows intermediate layer 46 being coated with layers 34 and 36. FIG. 6 illustrates the process of positioning a second sheet 28 (e.g., sheet 28) in proximity with first sheet 26 (e.g., sheet 26). The second sheet 28 includes a first polymer (e.g., vinyl), and the first sheet 26 includes a second polymer (e.g., polypropylene) having a material property (e.g., molecular structure, melting temperature, etc.) that is distinguishable from that of the first polymer. FIG. 6 also illustrates the operation of inserting weld medium 44 between sheets 26 and 28. Weld medium 44 comprises first layer 34 and second layer 36 joined to each other. The first layer 34 includes the first polymer (e.g., vinyl), and the second layer 36 includes the second polymer (e.g., polypropylene). FIG. 7 illustrates the process of welding the first layer 34 to the second sheet 28 and welding the second layer 36 to the first sheet 26, thereby joining sheets 26 and 28 via the weld medium 44. The welding of a weld medium layer to a curtain sheet preferably results in a molecular bonded joint of the two pieces, wherein the expression, “molecular bonded” means that the molecules of one piece become intermingled with the molecules of the adjoining piece. The actual welding process can be by any means well known to those of ordinary skill in the art, such as by way of ultrasonic vibration 48 and/or by heat 50 and/or use of RF welding techniques.

FIG. 8 shows an alternate example of a weld medium 52 comprising a first web or strands 54 (e.g., polypropylene) and a second web or strands 56 (e.g., polyurethane). The two webs 54 and 56 are interwoven to form a composite weave in which the material properties vary through a cross-section of the weld medium 52. The drawing of FIG. 8 shows first web 54 (e.g., polypropylene strands) running vertically and interweaving with second web 56 (e.g., horizontal polyurethane strands). Weld medium 52 can then be used in joining a polyurethane sheet to a polypropylene sheet in a manner similar to that shown in FIGS. 6 and 7 by virtue of the fact that some of the structure is weldable to the polyurethane sheet (i.e., strands 56) and some of the structure is weldable to the polypropylene sheet (i.e., strands 56). The interweaving of the strands 54 and 56 provides the composite structure with adequate tear strength in a similar way to the inclusion of intermediate layer 46 in the example of FIG. 5.

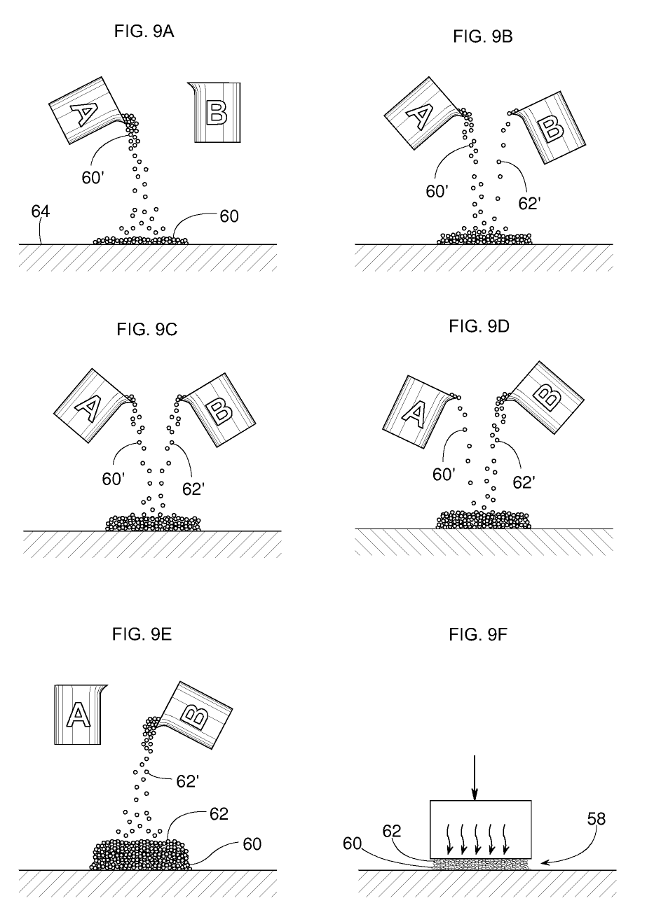

FIG. 9A-F depict a process of creating another example of a weld medium 58 comprising a first layer 60 (e.g., polypropylene) and a second layer 62 (e.g., polyurethane). Weld medium 58 is somewhat of an epitaxial composition that in this example gradually transitions from being mostly polypropylene on one side to being mostly polyurethane on an opposite side.

In FIG. 9A, polypropylene granules 60′ are deposited on a working surface 64 to create first layer 60 of polypropylene. As shown in FIG. 9B, some polyurethane granules 62′ are then mixed with polypropylene granules 60′, and the mostly polypropylene mixture is added to the granules 60′ previously deposited. An even mixture of polypropylene granules 60′ and polyurethane granules 62′ are deposited as shown in FIG. 9C. Some polypropylene granules 60′ are then mixed with polyurethane granules 62′ as shown in FIG. 9D, and the mostly polyurethane mixture is added to the granules 60′ and 62′ previously deposited. As shown in FIG. 9E, polyurethane granules 62′ are deposited to complete second layer 62, which is mostly comprised of polyurethane. The deposited mixture of granules 60′ and 62′ are compressed and heated to create solidified weld medium 58 as shown in FIG. 9F.

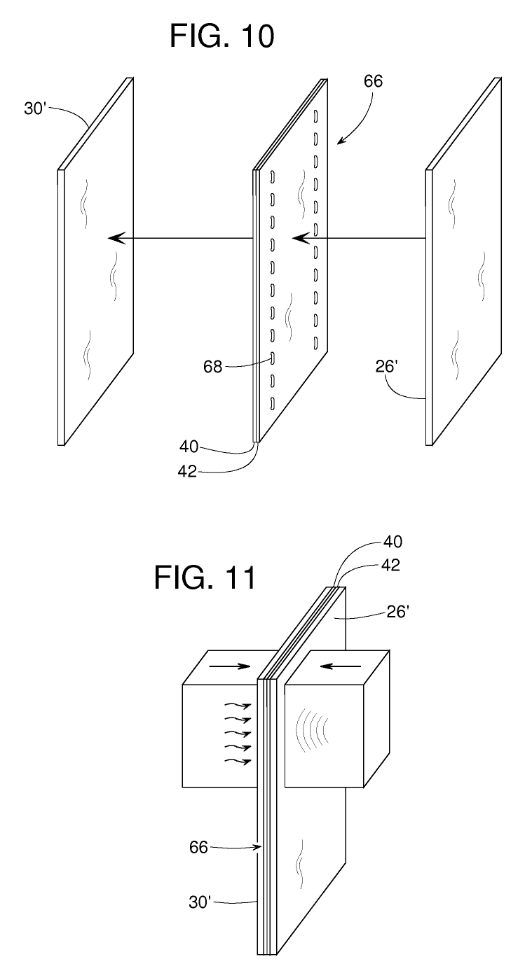

To ensure bonding among granules 60′ and 62′, it may be desirable to add a suitable binder or adhesive to the granule mixture prior to compressing and/or applying heat to the granules 60′ and 62′ as shown in FIG. 9F. Once completed, weld medium 58 can then be used in joining a polyurethane sheet to a polypropylene sheet in a manner similar to that shown in FIGS. 6 and 7. To do so, the weld medium 58 has to be properly oriented so that the portion that is primarily polypropylene is adjacent the polypropylene sheet and vice-versa for the polyurethane. Thus, the weld medium 58 has variable material properties through at least one cross-section of the weld medium 58 (in the example of FIG. 9, a vertical cross-section), and a preferred orientation in which weldable materials are placed adjacent to each other when the weld medium 58 is between distinguishable sheet material. This same cross-sectional variability and preferred orientation are also exhibited in the example of FIG. 5 and, in the examples shown in FIGS. 10, 11, 12 and 13 described below as well. The weld medium 52 of FIG. 8, however, may not have such a preferred orientation. In the instances where the weld medium 52 has a preferred orientation, the relative concentration or density, etc. of one polymer is high enough in a given volume or surface area to enable that volume or surface of the weld medium 52 to be welded to a sheet of the same or indistinguishable similar polymer. Another area or volume is the same for the other polymer and the other sheet.

In another example, shown in FIGS. 10 and 11, a weld medium 66 is made by mechanically fastening layers 40 and 42 together. In the example shown, thread 68 is used, although other means of mechanical fasteners (e.g., rivets) or chemical fasteners (e.g., glue, epoxy, etc.) could be used. In this example, weld medium 66 has layer 40 comprising polyurethane for welding to a polyurethane sheet 30′ and opposite-side layer 42 comprising polypropylene for welding to a polypropylene sheet 26′. To join other combinations of sheet materials, similar weld media can have other types of layers, such as polyurethane and vinyl, or just about any other imaginable combination of two thermoplastic materials. To avoid creating a final welded joint with a crevice, an appropriate sealant can be added between layers 40 and 42 prior to sewing layers 40 and 42 together.

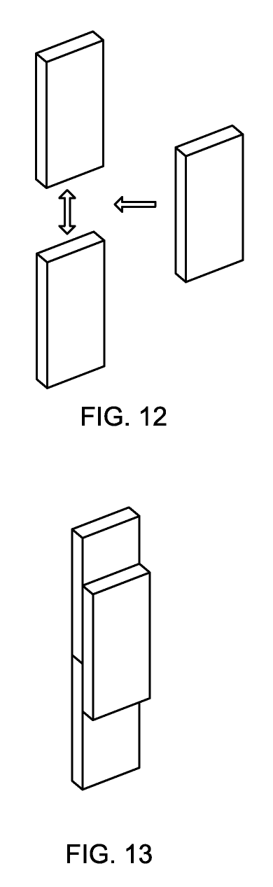

FIGS. 12 and 13 illustrate a process of positioning a first sheet 1202 in proximity to a second sheet 1204 to form, for example, a butt-weld between the sheets 1202 and 1204 via a weld medium 1206. In some examples, the first sheet 1202 includes a first polymer (e.g., vinyl), and the second sheet 1204 includes a second polymer (e.g., polypropylene) having a material property (e.g., molecular structure, melting temperature, etc.) that is distinguishable from that of the first polymer. The weld medium 1206 may include a first portion 1208 made of, for example, a vinyl material, and a second portion 1210 made of, for example, a polypropylene material. FIG. 13 depicts the first and second sheets 1202 and 1204 welded together via the welding medium 1206. Generally, as depicted in FIG. 13, the weld medium 1206 and the sheets 1202 and 1204 are positioned such that cross-sectional variability exists in a section co-planer with the general planer extent of the piece.

At least some of the aforementioned examples include one or more features and/or benefits including, but not limited to, the following:

In some examples, two sheets of two different thermoplastic materials are welded to each other by way of weld medium that includes a layer of each of the two materials.

In some examples, the weld medium's two layers are joined to each other by way of an intermediate layer.

In some examples, the weld medium's two polymeric layers melt at a temperature that is below a combustion temperature at which the intermediate layer can bum, thereby rendering the weld medium suitable for welding sheets made of the same materials as the weld medium's layers.

In some examples, the weld medium's two layers smoothly blend from one material at one layer to a second material at the other layer.

In some examples, the weld medium's two layers are comprised of intertwined strands, wherein each layer is partially exposed to the opposite layer's side.

In some examples, the weld medium joins a polypropylene sheet to a vinyl sheet.

In some examples, the weld medium joins a polypropylene sheet to a polyurethane sheet.

In some examples, the weld medium joins a polyurethane sheet to a vinyl sheet.

In some examples, the weld medium provides a sealed joint that is particularly suitable for a door curtain used in a food related environment.

Although certain example methods, apparatus and articles of manufacture have been described herein, the scope of the coverage of this patent is not limited thereto. On the contrary, this patent covers all methods, apparatus and articles of manufacture fairly falling within the scope of the appended claims either literally or under the doctrine of equivalents.

1. A plastic weld joint, comprising:
a first sheet comprising a first polymer;
a second sheet comprising a second polymer, wherein the first polymer includes a material property that is distinguishable from that of the second polymer; and
a weld medium comprising a first layer joined to a second layer, the first layer includes the first polymer, the second layer includes the second polymer, the first layer is molecularly bonded to the first sheet, and the second layer is molecularly bonded to the second sheet.

2. The plastic weld joint of claim 1, wherein there is more of the first polymer in the first layer than in the second layer.

3. The plastic weld joint of claim 1, further comprising an intermediate layer that joins the first layer to the second layer.

4. The plastic weld joint of claim 3, wherein the intermediate layer is comprised of a fabric.

5. The plastic weld joint of claim 3, wherein the first polymer and the second polymer melt at temperature that is below a combustion temperature at which the intermediate layer can burn.

6. The plastic weld joint of claim 1, wherein the first and second layers include a plurality of intermingled strands.

7. The plastic weld joint of claim 1, wherein the first polymer includes vinyl and the second polymer includes polypropylene.

8. The plastic weld joint of claim 1, wherein the first polymer includes vinyl and the second polymer includes polyurethane.

9. The plastic weld joint of claim 1, wherein the first polymer includes polyurethane and the second polymer includes polypropylene.

10. The plastic weld joint of claim 1, further comprising a door curtain comprised of at least one of the first sheet and the second sheet.

11. A method of joining two dissimilar sheets, the method comprising:
positioning a first sheet in proximity with a second sheet, wherein first sheet includes a first polymer, and the second sheet includes a second polymer having a material property that is distinguishable from that of the first polymer;
inserting a weld medium between the first sheet and the second sheet, wherein the weld medium comprises a first layer and a second layer joined to each other, the first layer includes the first polymer, and the second layer includes the second polymer;
welding the first layer to the first sheet; and
welding the second layer to the second sheet, thereby joining the first sheet to the second sheet via the weld medium.

12. The method of claim 11, wherein welding the first layer to the first sheet and welding the second layer to the second sheet are performed substantially simultaneously.

13. The method of claim 11, wherein welding the first layer to the first sheet and welding the second layer to the second sheet are performed by way of ultrasonic vibration.

14. The plastic weld joint of claim 11, wherein the weld medium includes an intermediate layer that joins the first layer to the second layer.

15. The plastic weld joint of claim 14, wherein the intermediate layer is comprised of a fabric.

16. The plastic weld joint of claim 11, wherein the first polymer includes vinyl and the second polymer includes polypropylene.

17. The plastic weld joint of claim 11, wherein the first polymer includes vinyl and the second polymer includes polyurethane.

18. The plastic weld joint of claim 11, wherein the first polymer includes polyurethane and the second polymer includes polypropylene.

19. A method of creating a door for a doorway, the method comprising:
positioning a first sheet in proximity with a second sheet, wherein first sheet includes a first polymer, and the second sheet includes a second polymer having a material property that is distinguishable from that of the first polymer;
inserting a weld medium between the first sheet and the second sheet, wherein the weld medium comprises a first layer and a second layer joined to each other, the first layer includes the first polymer, and the second layer includes the second polymer;
welding the first layer to the first sheet;
welding the second layer to the second sheet, thereby joining the first sheet to the second sheet to create a door curtain; and
moving the door curtain across the doorway.

20. The method of claim 19, wherein the weld medium includes an intermediate layer that joins the first layer to the second layer.

21. A plastic weld joint, comprising:
a first sheet comprising a first polymer;
a second sheet comprising a second polymer, wherein the first polymer includes a material property that is distinguishable from that of the second polymer; and
a weldable medium comprising the first polymer and the second polymer, wherein the concentration of the first and second polymers varies across at least one cross-section of the weldable medium, such that the weldable medium has an orientation in which a portion of the weldable medium has a sufficient concentration of the first polymer to enable it to be molecularly bonded to the first sheet.

22. A method of joining two dissimilar sheets, the method comprising:
positioning a first sheet in proximity with a second sheet, wherein first sheet includes a first polymer, and the second sheet includes a second polymer having a material property that is distinguishable from that of the first polymer;
orienting a weld medium comprising a first polymer and second polymer that vary in concentration across at least one cross-section of the weld medium so that a portion of the weld medium having a relatively higher concentration of the first polymer contacts the first sheet;
bridging the first sheet and second sheet with the oriented medium;
welding the portion of the weld medium having the relatively high concentration of the first polymer to the first sheet.
